(19) United States
(12) Patent Application Publication
(10) Pub. No.: US 2024/0424330 A1
(43) Pub. Date: Dec. 26, 2024

(54) FIRE EXTINGUISHER BRACKET HOLDER WITH EJECTION BUTTON SWITCH DEVICE

(71) Applicant: Xinliang SHI, Anyang (CN)

(72) Inventor: Xinliang SHI, Anyang (CN)

(21) Appl. No.: 18/213,906

(22) Filed: Jun. 26, 2023

(51) Int. Cl. A62C 13/78

(52) U.S. Cl. CPC A62C 13/78

(57) ABSTRACT

A fire extinguisher bracket holder with an ejection button switch device, including: a fire extinguisher bracket clamp, a fire extinguisher bracket fixing base, a fire extinguisher bracket clamp-and-fire extinguisher bracket fixing base fixing pin, a fire extinguisher bracket holder bolt, and a fire extinguisher bracket holder ejection button switch assembly, the fire extinguisher bracket fixing base being connected to the fire extinguisher bracket clamp through the fire extinguisher bracket clamp-and-fire extinguisher bracket fixing base fixing pin, the fire extinguisher bracket fixing base being connected to the fire extinguisher bracket holder ejection button switch assembly through an ejection link nut, and the fire extinguisher bracket clamp being connected to the fire extinguisher bracket holder ejection button switch assembly through the bolt. The fire extinguisher bracket holder eliminates the defect that the bolt of the conventional fire extinguisher bracket holder is easy to get loose and difficult to pull out.

### TECHNICAL FIELD

The present invention relates to the field of fire extinguisher bracket holder equipment, and in particular, to the field of fire extinguisher bracket holders.

### BACKGROUND

Since conventional fire extinguisher bracket holders are operated by directly inserting or pulling out a bolt, the bolt which has been pushed in has to be pulled out with great strength or cannot be pulled out, and abrasion is exacerbated when it cannot be pulled out or is pulled out with great strength, leading to the fact that during subsequent use, the bolt cannot be tightly retained and can easily get out when pushed in. As a result, the user's strength is wasted, and the service life of products is too short. fire extinguisher bracket holders in the prior art also cannot meet the operation of ejecting the bolt. Therefore, it is necessary to make an inventive improvement on the basis of conventional fire extinguisher bracket holders.

### SUMMARY

In view of the defect of the aforementioned technique, the present invention proposes a novel fire extinguisher bracket holder with an ejection button switch device, so as to solve the defect that the direct insertion and pulling operations of fire extinguisher bracket holders in the prior art lead to the waste of the user's strength and too short service life of products. When a bolt is inserted by a user, a ball retainer is pushed to move to the right, and after moving out of a trapezoidally cross-sectional annular projection of an ejection link nut, the ball retainer is restored, completing the retaining operation. After a button is pressed, the ball retainer is moved to the left, and after balls are released, the bolt is ejected out by a spring. The fire extinguisher bracket holder is easy to operate and convenient to use, can be operated by a single finger of the user, reducing the consumption of the user's strength, and reduce abrasion caused by violent insertion and pulling, prolonging the service life of the fire extinguisher bracket holder.

The present invention adopts the following technical solution: a fire extinguisher bracket holder with an ejection button switch device comprises: a fire extinguisher bracket fixing base, a fire extinguisher bracket clamp, a fire extinguisher bracket clamp-and-fire extinguisher bracket fixing base fixing pin, and a fire extinguisher bracket holder ejection button switch assembly, wherein the fire extinguisher bracket fixing base is connected to the fire extinguisher bracket clamp through the fire extinguisher bracket clamp-and-fire extinguisher bracket fixing base fixing pin, the fire extinguisher bracket fixing base is connected to the fire extinguisher bracket holder ejection button switch assembly through an ejection link nut, and the fire extinguisher bracket clamp is connected to the fire extinguisher bracket holder ejection button switch assembly through a bolt.

Further, the fire extinguisher bracket holder ejection button switch assembly comprises: an ejection link nut, a button, a bolt-type conical copper post, a spring a, a spring b, a spring c, balls, and a ball retainer, the ejection link nut being connected to the fire extinguisher bracket fixing base through threads, the button being connected to the ball retainer through the bolt-type conical copper post, the ball retainer being connected into the ejection link nut, the spring a being arranged on the surface of the bolt-type conical copper post between the ejection link nut and the button, the spring b being arranged on the surface of the ball clamp between the ejection link nut and the right step of the ball clamp, and the spring c being arranged inside the ball clamp between the balls and the bolt-type conical copper post.

Further, an annular projection with an isosceles trapezoid-shaped cross section is adopted in the hole of the ejection link nut to retain the bolt.

Further, an annular projection with a rectangular cross section is adopted on the right side in the hole of the ejection link nut to position the spring a and the spring b.

Further, the upper surface of the left side of the ball retainer is provided with an annular projection with a right-angled trapezoid-shaped cross section to achieve a function of preventing the balls from getting out.

Further, four arrayed round holes are adopted in the left surface of the ball retainer to position the balls.

Further, a downward projection is adopted on the right side of the arrayed round holes of the ball retainer to position the spring b.

Further, the bolt-type conical copper post adopts a conical head to position the spring c.

As a further embodiment of the present invention, a multi-scale feature function output by the multi-level feature fusion algorithm model is:

$$\{ \begin{matrix}{F}_{1} = block 1 ( D ) & {F}_{2} = block 2 ( {F}_{1} ) \\ {F}_{3} = block 3 ( {F}_{2} ) & {F}_{4} = block 4 ( {F}_{3} )\end{matrix} \qquad ( 4 )$$

in formula (4), block1, block2, block3 and block4 are four ordered convolutional blocks of a backbone network, which are combined in order to form a whole feature extractor; F represents a multi-level fire extinguisher bracket clamp image feature map, and F₁, F₂, F₃ and F₄ represent multi-level feature maps of four different scales selected, respectively; D represents a global eigenvector of input bolt image data;
wherein in the operating process of the multi-level feature fusion algorithm model, the bolt image feature fusion process is as follows:

Spatial direction denoising: Firstly, the noise of the fire extinguisher bracket clamp image feature map is reduced from the spatial position; for each multi-level feature map F, a spatial weight matrix W_{S} is calculated by the following formula:

$${W}_{S} ( i , j ) = {f}_{S 2} [ {f}_{S 1} ( F ( i , j ) ) ] i ∈ H , j ∈ W \qquad ( 5 )$$

in formula (5), ƒ_{S} is a combination of a fully connected layer and a nonlinear activation function Sigmoid, wherein ƒ_{S1} reduces the dimensionality of F from C to C/16 and a function ƒ_{S2} of correcting ReLU then reduces C/16 to 1, followed by the function of the Sigmoid function (S), S1 and S2 which are two FC layers with nonlinear activation function can understand the significance of eigenvectors at the (i,j) position, and the feature maps are weighted by a weighting matrix obtained by training:

$${F}^{′} ( i , j , k ) = {W}_{S} ( i , j ) * F ( i , j , k ) k ∈ C \qquad ( 6 )$$

in formula (6), all the fire extinguisher bracket clamp image data elements of F′ are weighted according to the importance degree at the (i, j) position, so as to achieve denoising in spatial directions;
Denoising in channel directions: The fire extinguisher bracket clamp image data feature maps are further denoised along feature channels; and the denoising function W_{C} is:

$${W}_{C} ( k ) = \frac{1}{H \times W} {\sum }_{i = 0}^{H} {\sum }_{j = 0}^{W} {F}_{C} ( i , j ) \qquad ( 7 )$$

the transformed weighting matrix is expressed by W′_{C}, and the relationship between W′_{C} and W_{C} is expressed as:

$${W}_{C}^{′} = {f}_{C 2} [ {f}_{C 1} ( {W}_{C} ) ] \qquad ( 8 )$$

The fire extinguisher bracket clamp image data feature map F″ is weighted again through dot product operation along the channels, so as to achieve the objective of denoising in the channel directions, and the dot product operation is as follows:

$${F}^{″} ( i , j , k ) = {W}_{C}^{′} ( k ) * {F}^{′} ( i , j , k ) \qquad ( 9 )$$

multi-level feature fusion is then performed; after (4) to (9), a denoised fire extinguisher bracket clamp image feature map of F is obtained, F is integrated into a global eigenvector D, and the elements in the kth channel of D are calculated as follows:

$$D ( k ) = \frac{1}{H \times W} {\sum }_{i = 0}^{H} {\sum }_{j = 0}^{W} {F}^{″} ( i , j ) \qquad ( 10 )$$

the global eigenvectors D₁, D₂, D₃ and D₄ corresponding to F₁, F₂ and F₃ represent the fire extinguisher bracket clamp image features under different measurement conditions, and the feature fusion output is:

$${D}_{0} = concat ( {D}_{1} , {D}_{2} , {D}_{3} , {D}_{4} ) \qquad ( 11 )$$

D0 is obtained by connecting D1, D2, D3 and D4 in series.

### Positive and Beneficial Effects

According to the present invention, by means of the ejection button switch device, the operations of inserting and pulling out the bolt are made simple and easy. The bolt can be retained by the ball retainer fitted in the ejection link nut after being inserted; the bolt can be ejected out by the spring in the ball retainer; the ball retainer can be restored for tight retaining by the spring on the surface of the ball retainer after the bolt is inserted; the function of ejecting out the bolt can be implemented by the button; the bolt-type conical copper post can transfer force from the button to the ball retainer; and the button pressed can be restored by the spring arranged on the surface of the bolt-type conical copper post between the ejection link nut and the button. Thus, the whole operation of pressing the button to eject out the bolt can be carried out. The consumption of strength of the user is reduced, and abrasion caused by violent insertion and pulling is reduced, prolonging the service life of the fire extinguisher bracket holder.

### BRIEF DESCRIPTION OF DRAWINGS

In order to more clearly illustrate the technical solution in embodiments of the present invention or the prior art, the accompanying drawings which need to be used in the description of the embodiments or the prior art will be introduced briefly below. Apparently, the accompanying drawings described below are merely some embodiments of the present invention, and those of ordinary skill in the art can also obtain other accompanying drawings according to these drawings without making creative efforts. Among the accompanying drawings:

FIG. 1 is a schematic front view of the overall structure of a fire extinguisher bracket holder;

FIG. 2 is a schematic diagram of the assembly of an ejection button switch device of the fire extinguisher bracket holder;

### REFERENCE NUMERALS

1—Fire extinguisher bracket fixing base; 2—Fire extinguisher bracket clamp; 3—fire extinguisher bracket holder ejection button switch assembly; 4—Fire extinguisher bracket clamp-and-fire extinguisher bracket fixing base fixing pin; 5—Ejection link nut; 6—Button; 7—Bolt-type conical copper post; 8—Spring a; 9—Spring b; 10—Spring c; 11—Ball; 12—Ball retainer; 13—Bolt.

### DETAILED DESCRIPTION OF THE EMBODIMENTS

Preferred embodiments of the present invention will be described below with reference to the accompanying drawings. It should be understood that the embodiments described herein are merely intended to illustrate and explain the present invention rather than to limit the present invention.

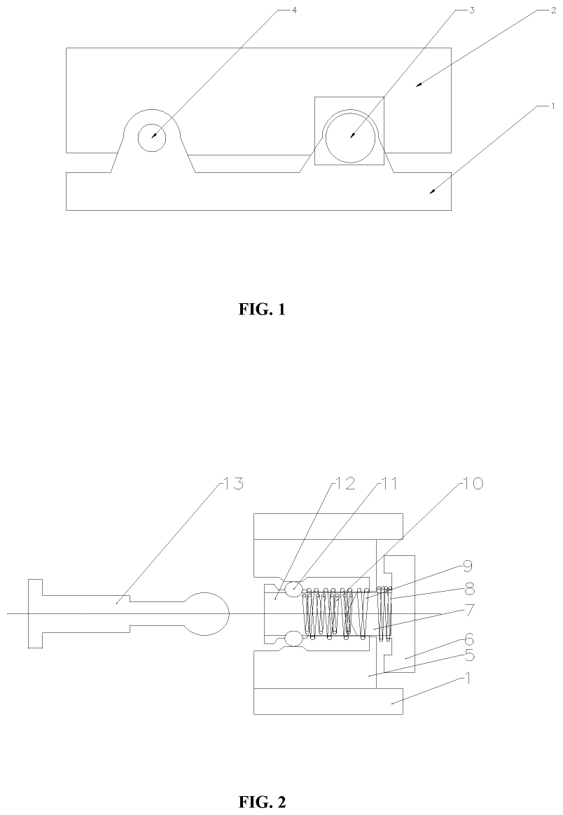

As shown in FIG. 1 and FIG. 2, the present invention relates to a fire extinguisher bracket holder with an ejection button switch device, including: a fire extinguisher bracket fixing base 1, a fire extinguisher bracket clamp 2, a fire extinguisher bracket clamp-and-fire extinguisher bracket fixing base fixing pin 4, and a fire extinguisher bracket holder ejection button switch assembly 3, the fire extinguisher bracket fixing base 1 being connected to the fire extinguisher bracket clamp 2 through the fire extinguisher bracket clamp-and-fire extinguisher bracket fixing base fixing pin 4, the fire extinguisher bracket fixing base 4 being connected to the fire extinguisher bracket holder ejection button switch assembly 3 through an ejection link nut 5, and the fire extinguisher bracket clamp 2 being connected to the fire extinguisher bracket holder ejection button switch assembly 3 through a bolt 13.

In the embodiments of the present invention, the fire extinguisher bracket holder ejection button switch assembly includes: an ejection link nut 5, a button 6, a bolt-type conical copper post 7, a spring a 8, a spring b 9, a spring c 10, balls 11, and a ball retainer 12, the ejection link nut 5 being connected to the fire extinguisher bracket fixing base 1 through threads, the button 6 being connected to the ball retainer 12 through the bolt-type conical copper post 7, the ball retainer 12 in which the balls 11 are fitted being connected into the ejection link nut 5, the spring a 8 being arranged on the surface of the bolt-type conical copper post 7 between the ejection link nut 5 and the button 6, the spring b being arranged on the surface of the ball clamp 12 between the ejection link nut 5 and the right step of the ball clamp 12, and the spring c being arranged inside the ball clamp 12 between the balls 11 and the bolt-type conical copper post 7.

Since the present invention adopts the fire extinguisher bracket holder ejection button switch assembly 3 to replace the conventional operation mode of inserting and pulling out the bolt, that is, the bolt 13 is inserted or pulled out by operating the fire extinguisher bracket holder ejection button switch assembly 3, the situation that the bolt 13 cannot be tightly retained when inserted by the user or has to be pulled out with great strength is prevented, and the problem of severe abrasion of the product caused by the operations of insertion and pulling is reduced, prolonging the service life of the product.

According to the present invention, by adopting an annular projection with an isosceles trapezoid-shaped cross section in the hole of the ejection link nut 5, the balls 11 on the ball retainer 12 can be released after the ball retainer 12 is moved to the left or the right, and can only be tightly retained when located at the position of the isosceles trapezoid-shaped annular projection. Thus, the bolt 13 can be inserted when the ball retainer 12 is moved to the right, and pulled out when the ball retainer 12 is moved to the left, and can be tightly retained when the balls 11 are located at the position of the isosceles trapezoid-shaped annular projection.

According to the present invention, the left side of the spring a 8 and the right side of the spring b 9 are positioned by adopting an annular projection with a rectangular cross section on the right side in the hole of the ejection link nut 5, the left side of the spring b 9 is positioned by a downward step on the right side of arrayed round holes of the ball retainer 12, and thereby, the ball retainer 12 can be restored after being moved to the right, so that after the bolt 13 is inserted into the ball retainer 12, the balls 11 on the ball retainer 12 move to under the isosceles trapezoid-shaped projection of the ejection link nut 5 to implement the tight retaining function. The right side of the spring a 8 is positioned by the left surface of the button 6, so that the button 6 can be restored under the elastic force of the spring a 8 after being pressed.

According to the present invention, the balls 11 are positioned by the four arrayed round holes in the left surface of the ball retainer 12, so that the balls can move along with the ball retainer 12. Thus, when the balls 11 moving along with the ball retainer 12 bumps into the left annular projection with the isosceles trapezoid-shaped cross section on the ejection link nut 5, the tight retaining function is implemented, and when the balls 11 get away from the isosceles trapezoid-shaped annular projection, the releasing function is implemented.

According to the present invention, the upper surface of the left side of the ball retainer 12 is provided with an annular projection with a right-angled trapezoid-shaped cross section to achieve a function of preventing the balls 11 from getting out. Thus, when the ball retainer 12 is moved to the left, the balls 11 can be blocked by the boss on the left from rolling out.

According to the present invention, after entering the ball retainer 12, the spring c 10 can touch the left conical head of the bolt-type conical copper post 7 and be positioned, preventing the problem that the spring c 10 is severely deformed and cannot be restored due to the spring c 10 not being fixed after the bolt 13 is inserted, greatly prolonging the service life of the present invention.

According to the present invention, because the left side of the bolt-type conical copper post 7 is connected with the ball retainer 12 and the right side is connected with the button 6, force can be transferred from the button 6 to the ball retainer 12. Thus, when the button 6 is pressed, the ball retainer 12 is moved to the left to release the balls 11, so that the elastic force of the spring c 10 is released to ejected out the bolt 13 after the balls 11 are released.

In a specific embodiment, the operation of ejecting out the bolt (13) by means of the spring c (10) should meet:

$${E}_{f} = {E}_{p} \qquad ( 1 )$$

in formula (1), E represents energy, f represents friction, p represents elastic force, and E_{f} represents energy consumed by the friction between the bolt (13) and the ball retainer (12);
Eₚ represents the elastic potential energy generated by the compression of the spring (c) (10);

$${E}_{f} = {fmgx}_{1} \qquad ( 2 )$$

in formula (2), E_{f} represents energy consumed by the friction between the bolt (13) and the ball retainer (12), f represents a friction coefficient between the bolt (13) and the ball retainer (12), m represents the mass of the bolt (13), g represents gravitational acceleration, and x₁ represents the distance by which the bolt (13) has been ejected out;

$${E}_{p} = \frac{1}{2} {kx}_{2}^{2} \qquad ( 3 )$$

in formula (3), E_{P} represents the elastic potential energy generated by the compression of the spring c (10), k represents the stiffness of the spring c (10), and x₂ represents the distance by which the spring c (10) has been compressed.

Although the specific embodiments of the present invention have been described above, those skilled in the art should understand that these specific embodiments are merely illustrative, and those skilled in the art can make various omissions, replacements and changes to the details of the aforementioned method and system without departing from the principle and essence of the present invention. For example, it is within the scope of the present invention to combine the aforementioned method steps so as to perform substantially the same function according to substantially the same method to achieve substantially the same result. Therefore, the scope of the present invention is defined only by the appended claims.

What is claimed is:

1. A fire extinguisher bracket holder with an ejection button switch device, comprising: a fire extinguisher bracket fixing base, a fire extinguisher bracket clamp, a fire extinguisher bracket clamp-and-fire extinguisher bracket fixing base fixing pin, and a fire extinguisher bracket holder ejection button switch assembly, wherein the fire extinguisher bracket fixing base is connected to the fire extinguisher bracket clamp through the fire extinguisher bracket clamp-and-fire extinguisher bracket fixing base fixing pin, the fire extinguisher bracket fixing base is connected to the fire extinguisher bracket holder ejection button switch assembly through an ejection link nut, and the fire extinguisher bracket clamp is connected to the fire extinguisher bracket holder ejection button switch assembly through a bolt; wherein the fastening force of the fire extinguisher bracket clamp and the fire extinguisher bracket holder ejection button switch assembly is detected by an oscillatory wave detection circuit, and failure in the fastening process is diagnosed by a multi-level feature fusion model; wherein the operating mode of the oscillatory wave detection circuit is as follows: the torque, force, displacement, or direction of the fastening button are sensed by a signal acquisition sensor, sensed analog data information is converted into digital data information; the same partial discharge pulse is propagated to both ends of the bolt, with an incident wave being directly propagated to the receiving end of the fire extinguisher bracket clamp and a reflected wave first reaching the other end of the fire extinguisher bracket holder ejection button switch assembly and then being reflected back to the receiving end of the instrument; and the position of the fastening force is calculated based on the time difference between the incident wave and the reflected wave, the pulse propagation speed and the length of the bolt, completing the detection of the fastening force of the bolt.

2. The fire extinguisher bracket holder with the ejection button switch device according to claim 1, wherein the fire extinguisher bracket holder ejection button switch assembly comprises: an ejection link nut, a button, a bolt-type conical copper post, a spring a, a spring b, a spring c, balls, and a ball retainer, the ejection link nut being connected to the fire extinguisher bracket fixing base through threads, the button being connected to the ball retainer through the bolt-type conical copper post, the ball retainer being connected into the ejection link nut, the spring a being arranged on the surface of the bolt-type conical copper post between the ejection link nut and the button, the spring b being arranged on the surface of the ball clamp between the ejection link nut and the right step of the ball clamp, and the spring c being arranged inside the ball clamp between the balls and the bolt-type conical copper post.

3. The fire extinguisher bracket holder with the ejection button switch device according to claim 2, wherein an annular projection with an isosceles trapezoid-shaped cross section is adopted in the hole of the ejection link nut to retain the bolt.

4. The fire extinguisher bracket holder with the ejection button switch device according to claim 2, wherein an annular projection with a rectangular cross section is adopted on the right side in the hole of the ejection link nut to position the spring a and the spring b.

5. The fire extinguisher bracket holder with the ejection button switch device according to claim 2, wherein four arrayed round holes are adopted in the left surface of the ball retainer to position the balls.

6. The fire extinguisher bracket holder with the ejection button switch device according to claim 2, wherein a downward step is adopted on the right side of the arrayed round holes of the ball retainer to position the spring b.

7. The fire extinguisher bracket holder with the ejection button switch device according to claim 2, wherein the upper surface of the left side of the ball retainer is provided with an annular projection with a right-angled trapezoid-shaped cross section to achieve a function of preventing the balls from getting out.

8. The fire extinguisher bracket holder with the ejection button switch device according to claim 2, wherein the bolt-type conical copper post adopts a conical head to position the spring c.

9. The fire extinguisher bracket holder with the ejection button switch device according to claim 8, wherein in order for the spring c to eject out the bolt, the following formula shall be met:
$${E}_{f} = {E}_{p} \qquad ( 1 )$$
in formula (1), E represents energy, f represents friction, p represents elastic force, E_{f} represents energy consumed by the friction between the bolt and the ball retainer, and Eₚ represents elastic potential energy generated by the compression of the spring c;
$${E}_{f} = {fmgx}_{1} \qquad ( 2 )$$
in formula (2), E_{f} represents energy consumed by the friction between the bolt and the ball retainer, f represents a friction coefficient between the bolt and the ball retainer, m represents the mass of the bolt, g represents gravitational acceleration, and x₁ represents the distance by which the bolt has been ejected out; and
$${E}_{p} = \frac{1}{2} {kx}_{2}^{2} \qquad ( 3 )$$
in formula (3), Eₚ represents the elastic potential energy generated by the compression of the spring c, k represents the stiffness of the spring c, and x₂ represents the distance by which the spring c has been compressed.

10. The fire extinguisher bracket holder with the ejection button switch device according to claim 1, wherein a multi-scale feature function output by the multi-level feature fusion algorithm model is:
$$\{ \begin{matrix}{F}_{1} = block 1 ( D ) & {F}_{2} = block 2 ( {F}_{1} ) \\ {F}_{3} = block 3 ( {F}_{2} ) & {F}_{4} = block 4 ( {F}_{3} )\end{matrix} \qquad ( 4 )$$
in formula (4), block1, block2, block3 and block4 are four ordered convolutional blocks of a backbone network, which are combined in order to form a whole feature extractor; F represents a multi-level fire extinguisher bracket clamp image feature map, and F₁, F₂, F₃ and F₄ represent multi-level feature maps of four different scales selected, respectively; D represents a global eigenvector of input bolt image data;
wherein in the operating process of the multi-level feature fusion algorithm model, the bolt image feature fusion process is as follows:
denoising in spatial directions: the noise of the fire extinguisher bracket clamp image feature map is reduced from spatial positions; for each multi-level feature map F, a spatial weight matrix W_{S} is calculated by the following formula:
$${W}_{S} ( i , j ) = {f}_{S 2} [ {f}_{S 1} ( F ( i , j ) ) ] i ∈ H , j ∈ W \qquad ( 5 )$$
in formula (5), ƒ_{S} is a combination of a fully connected layer and a nonlinear activation function, Sigmoid, wherein ƒ_{S1} reduces the dimensionality of F from C to C/16 and a function ƒ_{S2} of correcting ReLU then reduces C/16 to 1, followed by the function of the Sigmoid function (S), S1 and S2 which are two FC layers with nonlinear activation function can understand the significance of eigenvectors at the (i,j) position, and the feature maps are weighted by a weighting matrix obtained by training:
$${F}^{′} ( i , j , k ) = {W}_{S} ( i , j ) * F ( i , j , k ) k ∈ C \qquad ( 6 )$$
in formula (6), all the fire extinguisher bracket clamp image data elements of F′ are weighted according to the importance degree at the (i,j) position to achieve denoising in spatial directions;
denoising in channel directions: the fire extinguisher bracket clamp image data feature maps are further denoised along feature channels; and the denoising function W_{C} is:
$${W}_{C} ( k ) = \frac{1}{H \times W} {\sum }_{i = 0}^{H} {\sum }_{j = 0}^{W} {F}_{C} ( i , j ) \qquad ( 7 )$$
the transformed weighting matrix is expressed by W′_{C}, and the relationship between W′_{C} and W_{C} is expressed as:
$${W}_{C}^{′} = {f}_{C 2} [ {f}_{C 1} ( {W}_{C} ) ] \qquad ( 8 )$$
the fire extinguisher bracket clamp image data feature map F″ is weighted again through dot product operation along the channels to achieve the objective of denoising in the channel directions, and the dot product operation is as follows:
$${F}^{″} ( i , j , k ) = {W}_{C}^{′} ( k ) * F ( i , j , k ) \qquad ( 9 )$$
multi-level feature fusion is then performed; after (4) to (9), a denoised fire extinguisher bracket clamp image feature map of F is obtained, F is integrated into a global eigenvector D, and the elements in the kth channel of D are calculated as follows:
$$D ( k ) = \frac{1}{H \times W} {\sum }_{i = 0}^{H} {\sum }_{j = 0}^{W} {F}^{″} ( i , j ) \qquad ( 10 )$$
the global eigenvectors D₁, D₂, D₃ and D₄ corresponding to F₁, F₂ and F₃ represent the fire extinguisher bracket clamp image features under different measurement conditions, and the feature fusion output is:
$${D}_{0} = ( {D}_{1} , {D}_{2} , {D}_{3} , {D}_{4} ) \qquad ( 11 )$$
D₀ is obtained by connecting D₁, D₂, D₃ and D₄ in series.
